(19) United States
(12) Patent Application Publication
(10) Pub. No.: US 2006/0210290 A1
(43) Pub. Date: Sep. 21, 2006

(54) Apparatus and method for forming image

(75) Inventor: Hiroyuki Okuyama, Shinagawa-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/371,412

(22) Filed: Mar. 9, 2006

(30) Foreign Application Priority Data
Mar. 16, 2005 (JP) 2005-74363

(51) Int. Cl. G03G 15/00

(52) U.S. Cl. 399/38

(57) ABSTRACT

An image forming apparatus according to embodiments of the invention includes: a reading unit that reads an image to generate original image data; an image-quality control unit that controls the image quality of the generated original image data; a file generating unit that generates an electronic file containing intermediate image data in an appropriate intermediate stage of the image-quality control and attribute information containing image-quality parameters for the image-quality control; an interface that exchanges the generated electronic file with an external device; and a recording unit that prints the image on the basis of the intermediate image data and the attribute information input from the external device via the interface.

### BACKGROUND OF THE INVENTION

1. Field of the Invention

The present invention relates to an apparatus and a method for forming an image, and in particular, it relates to an apparatus and a method for inputting, storing, and printing or displaying an input document or image.

2. Description of the Related Art

Conventional color copiers and digital color copiers (hereinafter, referred to as MFPs) are subjected to color control for each type of machines so as to output printed matter in a desired color.

In conventional color control of printers, a standard color space such as sRGB has been assumed as a color space for externally input color images; for an output color space, a color space that can be expressed by the toners of printers has been adopted. The output color space is expressed as a color space depending on devices such as a toner, thus forming a device-dependent color space. The difference between an input color space and an output color space has been coped with by pixel-by-pixel conversion processing.

On the other hand, MFPs having a scanner function have adopted their own device-dependent color space as an input color space, and a device-dependent color space that is expressed depending on the color of the toner as an output space, as with printers. The two device-dependent color spaces have been coped with by pixel-by-pixel conversion processing.

Printers, scanners, and MFPs have generally functioned as independent devices. Also MFPs having both of a scanner function and a printer function have not output in-process image data to the exterior.

However, in addition to an integrated copying function of a scanner function and a printer function, a single scanner function by connection with an external personal computer, a single printer function, recent MFPs have come to store image data that is generated by a scanner function in a built-in large-capacity hard disk, read the image data any required number of times, and print it by a printer function.

Electronic files on stored images are sometimes output to external device such as personal computers; conversely, they are input to the hard disks of MFPs from external device.

When image data is exchanged between different functions or devices, a color conversion process is required for each device because color spaces in which color reproduction is allowed differ among the devices. For color conversion, electronic files that are exchanged among the devices generally have a format in which attribute-information data indicative of the characteristics of the devices, which are described in a standard format called the ICC profile, is added to image data described in a standard format, such as JPEG. The color conversion using color-conversion information contained in the ICC profile allows reproduction of the same color even for different units (for example, a display unit and a printer unit) or different machines.

Japanese Unexamined Patent Application Publication No. 2004-64565 discloses a technique of image reproduction using the ICC profile.

The MFPs perform various image processing including controlling the density of a character or picture image, controlling the density of a base, enhancing the outline of a character, and smoothing a picture image, in addition to image processing for color reproduction such as color conversion and gamma conversion. Most of parameters for the various image processing can be set or changed on the control panel of MFPs as necessary to meet the preference of the user.

However, the attribute information data contained in the ICC profile principally aims at providing color reproducibility among different devices, so that it principally contains information on color reproduction (information on color conversion and gamma conversion). Accordingly, other image-processing information other than the color-reproduction information has not been described in an electronic file. This is because the ICC profile describes standardized data but does not support free description formats. One of the reasons is that attribute-information data that contains various pieces of image-processing information causes an increase in the size of electronic files.

The conventional method in which electronic files are exchanged between external devices using the ICC profile allows standardization of color reproduction. However, image-processing information other than for color reproduction, for example, image-processing parameters set to meet user's preference, such as density-control information, could not been stored in electronic files.

Consequently, when electronic files are transmitted from MFPs to external personal computers and they are again taken into the MFPs and printed, users had no other choice but to again set image processing parameters for density control using a control panel.

Also when electronic files containing the same image data are distributed to multiple MFPs and printed in multiple locations, users need to set image-processing parameters by individual MFPs again. This is very bothersome and makes it difficult to provide perfect reproducibility.

Japanese Unexamined Patent Application Publication No. 2004-64565 discloses a technique for image reproduction using the ICC profile. This is strictly for color reproducibility based on the ICC profile but is not a technique that ensures the reproducibility of various image-processing parameters set on a control panel.

### SUMMARY OF THE INVENTION

The present invention has been made in light of the above-described circumstances. Accordingly, it is an object of the invention to provide an apparatus and a method for forming an image capable of ensuring color reproduction and also reproduction of image-quality control set by a user.

In order to achieve the above object, an image forming apparatus according to a first aspect of the invention includes a reading unit that reads an image to generate original image data; an image-quality control unit that controls the image quality of the generated original image data; a file generating unit that generates an electronic file containing intermediate image data in an appropriate intermediate stage of the image-quality control and attribute information containing image-quality parameters for the image-quality control; an interface that exchanges the generated electronic file with an external device; and a recording unit that prints the image on the basis of the intermediate image data and the attribute information input from the external device via the interface.

In order to achieve the above object, an image forming apparatus according to a second aspect of the invention includes a reading unit that reads an image to generate original image data; an image-quality control unit that controls the image quality of the generated original image data; a storage unit that stores intermediate image data in an appropriate intermediate stage of the image-quality control and attribute information containing image-quality parameters for the image-quality control; and a recording unit that reads the intermediate image data and the attribute information stored in the storage unit and prints the image.

In order to achieve the above object, an image forming method according to a third aspect of the invention includes reading an image to generate original image data; controlling the image quality of the generated original image data; generating an electronic file containing intermediate image data in an appropriate intermediate stage of the image-quality control and attribute information containing image-quality parameters for the image-quality control; exchanging the generated electronic file with an external device; and printing the image on the basis of the intermediate image data and the attribute information input from the external device.

In order to achieve the above object, an image forming method according to a fourth aspect of the invention includes reading an image to generate original image data; controlling the image quality of the generated original image data; storing intermediate image data in an appropriate intermediate stage of the image-quality control and attribute information containing image-quality parameters for the image-quality control; and reading the stored intermediate image data and attribute information and printing the image.

The apparatus and method for forming an image according to embodiments of the invention can ensure color reproduction and also the reproduction of image-quality control set by a user.

### BRIEF DESCRIPTION OF THE DRAWINGS

FIG. 1 is a block diagram of an image forming apparatus according to a first embodiment of the invention;

FIG. 2 is a diagram showing a detailed structural example of an image-quality control unit of the image forming apparatus according to the first embodiment of the invention;

FIG. 3 is a first flowchart for the process step of an image forming method according to the invention;

FIG. 4 is a second flowchart for the process step of the image forming method according to the invention; and

FIG. 5 is a block diagram of an image forming apparatus according to a second embodiment of the invention.

### DESCRIPTION OF THE PREFERRED EMBODIMENTS

An apparatus and a method for forming an image according to embodiments of the invention will be described with reference to the drawings.

### First Embodiment

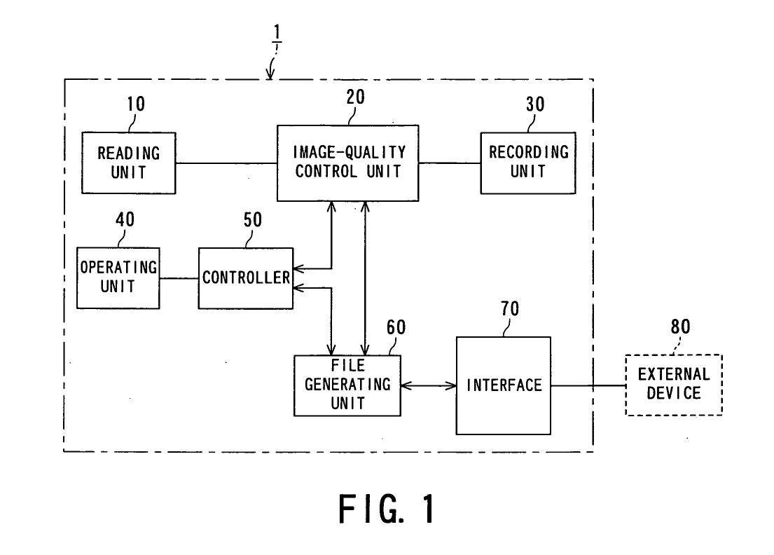

FIG. 1 is a block diagram of an image forming apparatus 1 according to a first embodiment of the invention.

The image forming apparatus 1 includes a reading unit 10 that reads an image to generate original image data, an image-quality control unit 20 that controls the image quality of the generated original image data, and a recording unit 30 that prints the quality-controlled image data.

The image forming apparatus 1 includes a file generating unit 60 that generates an electronic file containing intermediate-image data at an appropriate intermediate stage of image-quality control and attribute information containing image-quality parameters for image-quality control; an interface 70 that transfers the generated electronic file with an external device 80; a controller 50 that sets image-quality parameters etc. to the image-quality control unit 20; and an operating unit 40 for a user to set or change image-quality parameters.

The reading unit 10 is used to perform a scanner function, and includes, for example, a light source (not shown), a CCD, an optical system, and an optical drive system. Original image data converted to an electrical signal by a photoelectric transducer such as a CCD is converted to digital original image data via an A/D converter (not shown). The original image data output from the reading unit 10 is a digital signal expressed by a color space of, for example, RGB.

The image-quality control unit 20 controls image quality by giving various image processing to original image data. The image-quality control unit 20 may be achieved by either hardware such as a logic circuit or an appropriate single or multiple image-processing processors.

The image-quality control unit 20 provides individual image processing such as color conversion and filtering to original image data in sequence (in series), as will be described later, to allow printing of an image of a desired quality.

The recording unit 30 is means for printing an image in response to a signal output from the image-quality control unit 20, for example, a signal expressed by a color space of CMYK. There are an inkjet method, an electrophotographic method, and a thermal transfer method. The invention may use any of them.

The operating unit 40 corresponds to the control panel of MFPs. A user can set or change various parameters for the quality of an image to be printed by operating the operating unit 40.

The controller 50 sets predetermined various image-quality parameters and image-quality parameters set or changed by the user to the image-quality control unit 20. The controller 50 can be constructed of a CPU. The various image-quality parameters are set in appropriate registers of an image processor of the image-quality control unit 20 under the control of the CPU.

The file generating unit 60 generates an electronic file from attribute information and intermediate image data. The attribute information includes color-reproduction information described as the ICC profile; various image-quality parameters that are set by the user using the operating unit 40; and device-identifying information that allows device identification of the image forming apparatus 1.

The intermediate image data is image data at the intermediate stage of image processing that is executed step by step by the image-quality control unit 20. This may include image data input to the image-quality control unit 20 or image data output from the image-quality control unit 20.

The interface 70 is means for exchanging an electronic file generated by the file generating unit 60 with the external device 80, such as a personal computer, or another image forming apparatus 1. The interface 70 is constructed of an appropriate communication interface such as a USB or LAN, but is not limited to a specific type or system.

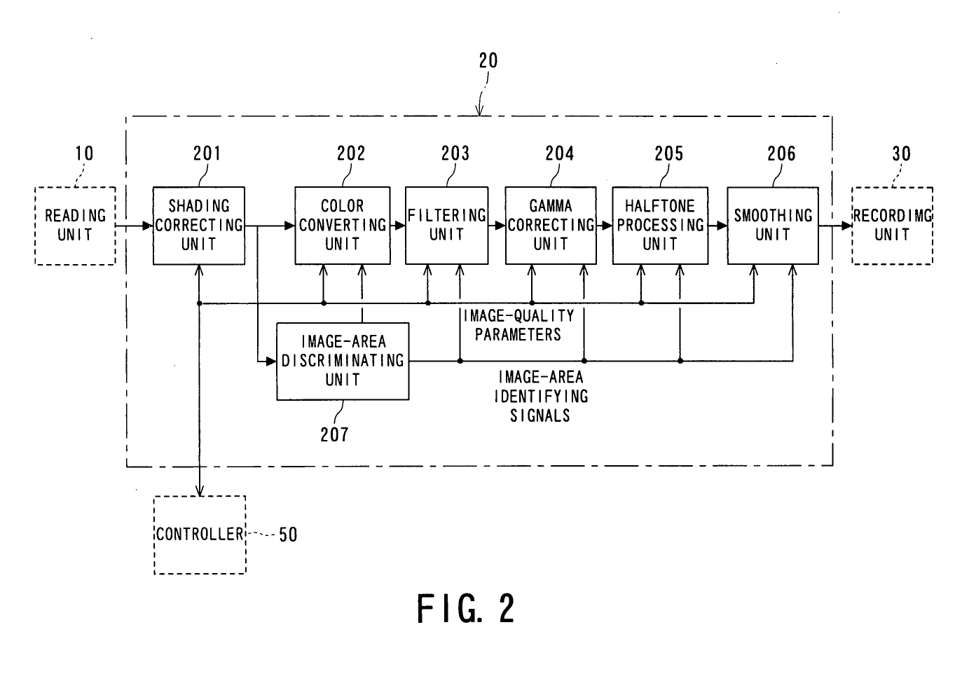

FIG. 2 is a block diagram showing a detailed structural example of the image-quality control unit 20.

The image-quality control unit 20 includes image processing units such as a shading correcting unit 201, a color converting unit 202, a filtering unit 203, a gamma correcting unit 204, a halftone processing unit 205, and a smoothing unit 206 connected in series. Image-area identifying signals are applied to the image processing units from an image-area discriminating unit 207.

In addition, the controller 50 connects to the image processing units so as to allow setting of color reproduction information and various image-quality parameters.

The shading correcting unit 201 corrects the deviation of the axial light-intensity distribution by the light source of the reading unit 10 (the light intensity at the center is high, and that at both ends is low) so as to become even in the axial direction.

The color converting unit 202 converts a color space of colors generated by the reading unit 10 (an RGB color space in general) to a color space of colors that can be reproduced by the recording unit 30 (a CMYK color space in general).

The filtering unit 203 provides input image data with two-dimensional space filtering of a specified shape, thereby enhancing the outline of a character or smoothing a picture image.

The gamma correcting unit 204 corrects the density characteristic of the CMYK color materials for the input values of CMYK.

The halftone processing unit 205 sets the size, spacing, or density of dots to be printed by the method of the recording unit 30 so that the halftone levels of CMYK are appropriately expressed by the recording unit 30.

The smoothing unit 206 optimizes the size, pattern, and the degree of overlap of adjacent dots so that characters are printed smoothly.

The image-area discriminating unit 207 discriminates whether a specific pixel to be processed in image data is in a character image area or a picture area, and transmits the kind of the image area to the image processing units. The image processing units perform the optimum image processing to the type of the image area; for example, for a pixel in a character image area, the image-area discriminating unit 207 performs image processing of enhancing the outline; for a pixel in a picture area, it performs image processing of smoothing.

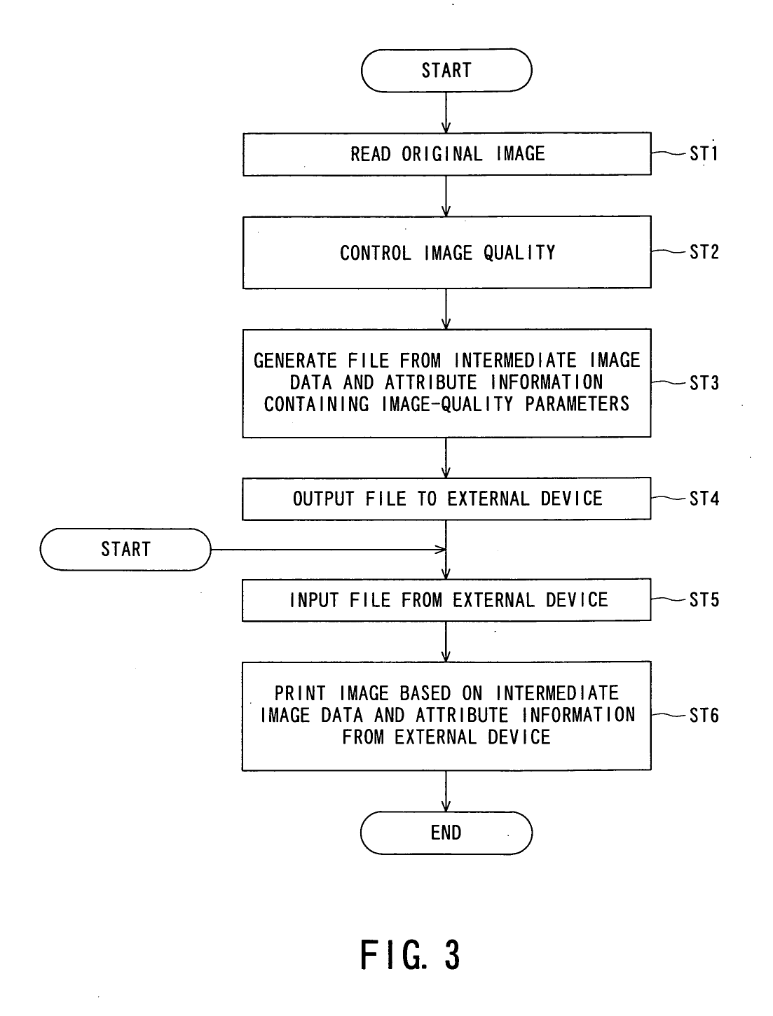

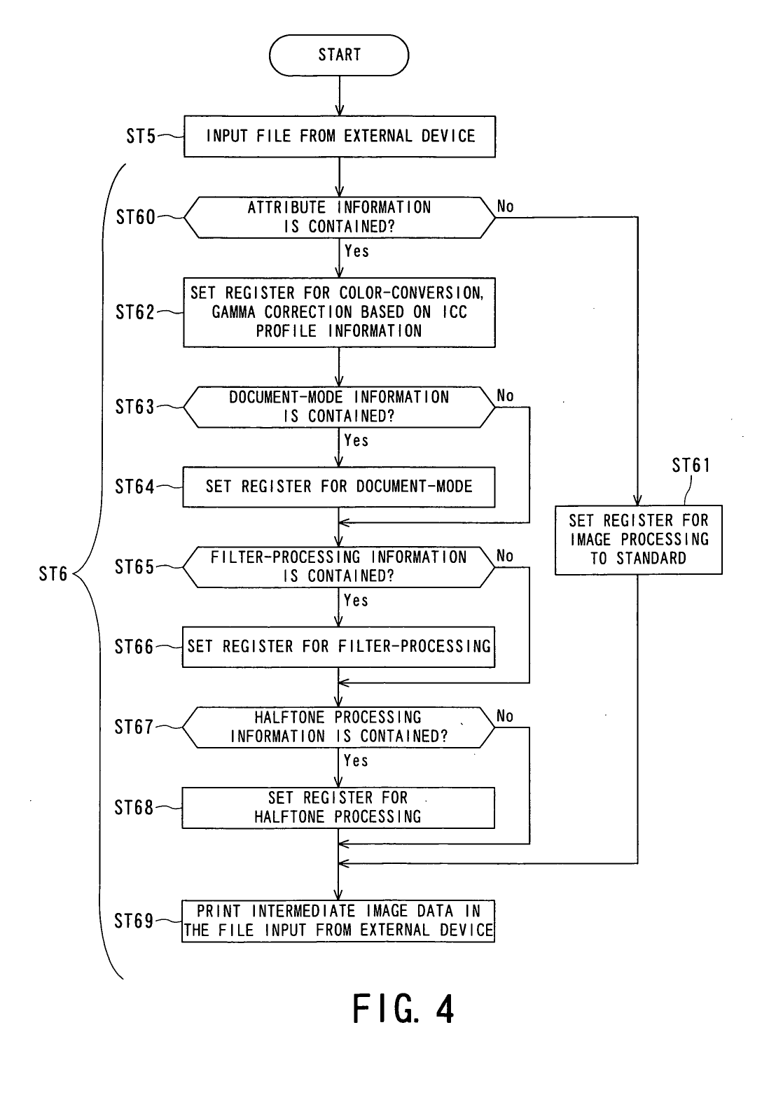

The operation of the image forming apparatus 1 with such a structure will be described with reference to the flowcharts of FIGS. 3 and 4, and the block diagrams of FIGS. 1 and 2.

First, the reading unit 10 reads an image (original) to generate original image data by the operation by the user using the operating unit 40 (step ST1 in FIG. 3).

The original image data is processed in sequence by the image processing units (the shading correcting unit 201 through smoothing unit 206) shown in FIG. 2, and is finally output to the recording unit 30. The read image is then printed.

When the user has made no change to image quality for the operating unit 40, the controller 50 sets predetermined standard image-quality parameters for the image processing units (the shading correcting unit 201 to the smoothing unit 206).

The user can control the image quality from the standard quality to desired quality by operating the operating unit 40 (step ST2 in FIG. 3). The image quality may be controlled either after the printed image is seen or before printing.

The file generating unit 60 generates an electronic file from intermediate image data and attribute information that contains image-quality parameters.

The intermediate image data is in-process image data extracted from any of connecting points of the image processing units (the shading correcting unit 201 to the smoothing unit 206) shown in FIG. 2. The point at which image data is extracted is not particularly limited; for example, image data at the input point of the halftone processing unit 205 is extracted as intermediate image data. The intermediate image data is temporarily stored in an appropriate memory (not shown) of the file generating unit 60.

The attribute information is information that is edited or generated by the file generating unit 60, and includes the following information:

(a) device identifying information;

(b) image-area discriminating information;

(c) document-mode setting information;

(d) density-control-level setting information;

(e) base-control-level setting information;

(f) color-conversion-table number information;

(g) filter-number information;

(h) screen-number information;

(i) color-conversion-table content information;

(j) filter-content information; and

(k) screen-content information.

The device identifying information here is information for identifying the image forming apparatus 1, and contains the manufacturer, the type, the serial production number, and so on. Containing the serial production number allows individual specification of an image forming apparatus 1 that has generated image data (intermediate image data) contained in the electronic file.

The image-area discriminating information “enables” or “disables” the function of the image-area discriminating unit 207 (refer to FIG. 2) to automatically discriminate whether a character image area or a picture area. The setting of “enable” or “disable” can be set or changed by the user using the operating unit 40.

The document-mode setting information indicates the document mode such as “a character-document mode” or “a picture-document mode” set by the user manually when the automatic image-area discriminating function is “disabled”.

The density-control-level setting information indicates the set control level of image density such as a character density or a picture density. It indicates one set value of multiple control levels in the range from the minimum value to the maximum value.

The base-control-level setting information indicates the set value of the density control level of the base color of a copy paper (close to white in general).

The color-conversion-table number information indicates the number of a color conversion table selected from multiple color conversion tables of the color converting unit 202 in the image forming apparatus 1. The color converting unit 202 can switch color conversion tables according to the kind of an object such as a character or a picture to achieve optimum color conversion for each object. The use of this information allows specification of one of multiple color conversion tables.

The color-conversion-table content information indicates the specifics of a color conversion table (the content of the table) in place of or in addition to identifying a color conversion table by number.

The filter-number information indicates the number of a filter selected from multiple filters of the filtering unit 203. The filtering unit 203 selects the optimum filter from multiple filters, depending on the kind of an object to be processed, such as a character or a picture. The use of this information allows specification of one of multiple filters.

The filter-content information indicates the specifics of a filter (for example, a filter factor) in place of or in addition to identifying the filter by number.

The screen-number information indicates the number of a screen selected from multiple screens of the halftone processing unit 205. The halftone processing unit 205 has multiple dot patterns called screens to achieve halftone level expression using color materials of CMYK. The use of this information allows specification of one of multiple screens.

The screen-content information indicates the specifics of a screen (for example, the size and spacing of dots) in place of or in addition to identifying the screen by number.

Since the above-described attribute information is contained in an electronic file, an electronic file can be generated in which attribute information when a specific image is read and printed by the recording unit 30 is integrally associated with its intermediate image data.

Then the generated electronic file is output to the external device 80 (step ST4). The external device 80 is, for example, a personal computer or a specific image processing unit.

The personal computer or the specific image processing unit can process intermediate image data as needed. The attribute information may be edited or processed by dedicated application software.

The external device 80 may be a display unit that displays image data.

In addition, the external device 80 may either an external memory that stores an electronic file or another image forming apparatus 1.

Then an electronic file is input from the external device 80 (step ST5). The electronic file is not limited to the electronic file that is output in step ST4 or the electronic file that is processed externally after being output. For example, it may be an electronic file generated by another image forming apparatus 1. Alternatively, it may be a new file generated by a personal computer, a specific image processing unit or the like.

The image is then printed by the recording unit 30 of the image forming apparatus 1 according to intermediate image data and the attribute information in the electronic file that is input from the external device 80 (step ST6).

FIG. 4 shows the details of the step ST6 in FIG. 3.

After the electronic file has been input, it is determined whether or not the electronic file contains attribute information (step ST60).

When the electronic file contains no attribute information, the program proceeds to step ST61, wherein a register for image processing is set to standard.

On the other hand, when the electronic file contains attribute information, the register for image processing is changed according to the attribute information.

When the attribute information contains only standard data specified by the ICC profile, or information on color reproduction, color-conversion parameters for color reproduction, gamma-correction parameters and so on are set according to the information (step ST62).

Then attribute information other than the standard data specified by the ICC profile is searched in sequence and registers etc. for image processing corresponding to the attribute information are changed or set (steps ST63 to ST 68). The attribute information here is, for example, the above-described information including (a) device identifying information to (k) screen-content information.

FIG. 4 shows only three pieces of attribute information, document-mode information, filter-processing information, and halftone processing information, while omitting part for the convenience of description. However, the invention is not limited to that.

After the register for each image processing has been set according to the attribute information, intermediate image data contained in the electronic file is input and printed by the recording unit 30.

With the image forming apparatus 1 according to the first embodiment, attribute information that contains, for example, image-quality information etc. that is set freely by the user with a control panel (the operating unit 40) or the like according to the user's desire, in addition to the conventional attribute information described in the ICC profile. An electronic file is thus generated corresponding to the intermediate image data processed according to the additional attribute information.

When the electronic file is temporarily output to the outside, where the intermediate image data is corrected or processed as needed and again taken back to the image forming apparatus 1 for printing, registers relating to image processing are automatically set according to the attribute information contained in the electronic file.

This eliminates the need for the user to control image quality again with a control panel or the like. Also, since the image-quality parameters that were controlled or set when the electronic file was generated are reproduced accurately, a print with the same image quality can be reproduced.

With the image forming apparatus 1 according to the first embodiment, since a second image-forming apparatus 1 having the same function is connected as the external device 80, the image quality controlled by the first image-forming apparatus 1 can be reproduced accurately by the second image-forming apparatus 1.

When the personal computer or the image processing unit connected as the external device 80 are constructed to support an electronic file that has the same form as that of the electronic file according to the invention, the need for further image-quality control can be eliminated through prior image-quality control by the personal computer or the image processing unit and transmission of the electronic file to the image forming apparatus 1.

Since the electronic file of the image forming apparatus 1 according to the first embodiment of the invention contains individual identifying information such as a product number, the origin at which a paper document is converted to the electronic document can be identified. Accordingly, even when the converted electronic document is transmitted to multiple locations via a communication line or the like, the origin of the original paper document can be identified.

### Another Embodiment

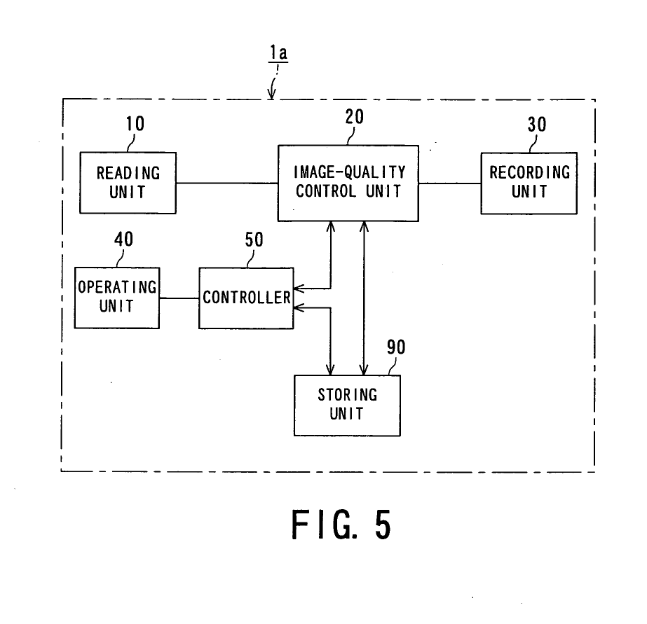

FIG. 5 is a block diagram of an image forming apparatus 1a according to a second embodiment of the invention. The image forming apparatus 1a according to the second embodiment includes a storage unit 90 that stores intermediate image data and attribute information, in place of the file generating unit 60 according to the first embodiment.

The storage unit 90 is constructed of, for example, a large-capacity hard disk. The storage unit 90 may be constructed of a writable and readable magnetic disk or an optical disk.

With the image forming apparatus 1a according to the second embodiment, the image-quality parameters that are set freely by the user with a control panel or the like are stored in the storage unit 90. Thus there is no need for the user to reset the image-quality parameters, and complete image-quality reproduction can be ensured when the same image is printed again.

With the structure in which the storage unit 90 is constructed of a writable and readable magnetic disk or an optical disk, the same advantages as those of the first embodiment can be provided through exchange of an electronic file with the external device via these recording media.

While the image forming apparatuses 1 and 1a according to the first and second embodiments have been described as the image forming apparatus 1 having a copy function in which a scanner function (image processing relating to the reading unit 10) and a printer function (image processing relating to the recording unit 30) are combined, the invention is not limited to that.

For example, even a single scanner function can provide similar advantages to those of the image forming apparatuses 1 and 1a owing to a structure in which an electronic file contains image-quality parameters for the scanner function as attribute information provides.

Even a single printer function can provide similar advantages to those of the image forming apparatuses 1 and 1a owing to a structure in which an electronic file contains image-quality parameters for the printer function as attribute information.

The invention is not limited to the foregoing embodiments but may be embodied by modification of the components without departing from the scope of the invention. Other various modifications may be made in the invention by an appropriate combination of the multiple components disclosed in the embodiments. For example, several components can be omitted from all the components of the embodiments. Components of the different embodiments may be combined as appropriate.

What is claimed is:

1. An image forming apparatus comprising:
a reading unit that reads an image to generate original image data;
an image-quality control unit that controls the image quality of the generated original image data;
a file generating unit that generates an electronic file containing intermediate image data in an appropriate intermediate stage of the image-quality control and attribute information containing image-quality parameters for the image-quality control;
an interface that exchanges the generated electronic file with an external device; and
a recording unit that prints the image on the basis of the intermediate image data and the attribute information input from the external device via the interface.

2. The image forming apparatus according to claim 1, further comprising an operating unit capable of changing the attribute information input from the external device.

3. An image forming apparatus comprising:
a reading unit that reads an image to generate original image data;
an image-quality control unit that controls the image quality of the generated original image data;
a storage unit that stores intermediate image data in an appropriate intermediate stage of the image-quality control and attribute information containing image-quality parameters for the image-quality control; and
a recording unit that reads the intermediate image data and the attribute information stored in the storage unit and prints the image.

4. The image forming apparatus according to claim 3, further comprising an operating unit capable of changing the attribute information read from the storage unit.

5. The image forming apparatus according to claim 1, wherein the attribute information contains color-conversion information and at least one of device identifying information, document-mode information, character-density information, picture-density information, base-density information, and image-filter information.

6. The image forming apparatus according to claim 3, wherein the attribute information contains color-conversion information and at least one of device identifying information, document-mode information, character-density information, picture-density information, base-density information, and image-filter information.

7. An image forming method comprising:
reading an image to generate original image data;
controlling the image quality of the generated original image data;
generating an electronic file containing intermediate image data in an appropriate intermediate stage of the image-quality control and attribute information containing image-quality parameters for the image-quality control;
exchanging the generated electronic file with an external device; and
printing the image on the basis of the intermediate image data and the attribute information input from the external device.

8. The image forming method according to claim 7, further comprising changing the attribute information input from the external device as needed.

9. An image forming method comprising:
reading an image to generate original image data;
controlling the image quality of the generated original image data;
storing intermediate image data in an appropriate intermediate stage of the image-quality control and attribute information containing image-quality parameters for the image-quality control; and
reading the stored intermediate image data and attribute information and printing the image.

10. The image forming method according to claim 9, further comprising changing the attribute information read from the storage unit.

11. The image forming method according to claim 7, wherein the attribute information contains color-conversion information and at least one of device identifying information, document-mode information, character-density information, picture-density information, base-density information, and image-filter information.

12. The image forming method according to claim 9, wherein the attribute information contains color-conversion information and at least one of device identifying information, document-mode information, character-density information, picture-density information, base-density information, and image-filter information.
